(19) United States
(12) Patent Application Publication
(10) Pub. No.: US 2008/0153333 A1
(43) Pub. Date: Jun. 26, 2008

(54) Electrical Connector Connectable in Water or in a Liquid Medium

(75) Inventor: Pierre Dubranna, Nuille Le Jalais (FR)

Correspondence Address: SUGHRUE MION, PLLC, 2100 PENNSYLVANIA AVENUE, N.W., SUITE 800, WASHINGTON, DC, 20037, US

(73) Assignee: CARRIER KHEOPS BAC, Le Mans (FR)

(21) Appl. No.: 11/792,916

(22) PCT Filed: Dec. 22, 2004
(86) PCT No.: PCT/FR2004/003337

§ 371 Date: Jan. 4, 2008

(51) Int. Cl. H01R 13/523

(52) U.S. Cl. 439/271

(57) ABSTRACT

The inventive electrical connector connectable in water comprises a rigid electrically insulated contact chamber (21) receiving the contact pin (5) of the connector male coupling element in a contact area (41), wherein a piston element (29) and the contact pin slide in said contact chamber (21) is such a way that they are sealingly connectable by at least two axially separated joints, one of which (45) is placed near said opening (27) and the second (45′) is placed downstream of the pin and the contact chamber contact area (9, 41) with respect to the opening (27), the surface of the piston element (29) between two joints (45, 45′) is connected to a chamber which is filled with an electrically insulating fluid (49), is arranged inside the connector element and is connected to an external flexible wall element (51) deformable in such a way that it makes it possible to introduce the contact pin (5) into the contact chamber (21) or to remove it therefrom, and the contact area is also filled with the electrically insulating fluid and separated from the remaining part of the connector by the third joint (47) of the piston element (29).

The invention relates to an electrical connector that can be connected in water or in a liquid medium and in particular, an electrical connector that can be connected in sea water.

Patents EP 0 493 375 and EP 0 251 655 disclose electrical connectors that can be connected in sea water, comprising two expansion chambers containing an electrically insulating fluid for drying the contact part of the connector when the male element of the connector is coupled in the corresponding female element, the external expansion chamber forming the body of the casing of the female connector element. However, this external, deformable expansion chamber mainly comprises a wall made of elastomer material, the external surface of which can be attacked by solvents, particularly in the case of oil drilling. Furthermore, the mobile shuttle receiving the contact pin of the male element is returned toward the front of the female element by means of a helical spring housed in the rear part of the shuttle housing. This arrangement makes it complicated to construct, particularly when it comprises multiple contact elements, and increases the coupling force in proportion to the number of contact elements.

The invention aims to remedy these drawbacks and proposes an electrical connector connectable in water or in a liquid medium, comprising two complementary connector elements, respectively a male element and a female element intended to be coupled together in service in said liquid medium, the male connector element comprising at least one contact pin projecting from the connector element, and the female connector element comprising at least one opening for the pin to pass through to couple said connector elements, this opening being blocked in the uncoupled position by an electrically insulating piston element fitted to slide inside the connector element in an electrically insulating rigid contact chamber, which receives via a contact area the contact pin of the male connector element on coupling, the piston element and the contact pin also sliding in a sealed manner on coupling into the contact chamber via at least two axially separate seals, one of which is located close to said opening and the second being located downstream of the contact area of the pin and of the contact chamber with respect to the opening, the surface of the piston element between the two seals being linked to a chamber filled with electrically insulating fluid, formed inside the connector element, this chamber being linked to an external flexible wall element that deforms to accept the insertion or removal of the contact pin into or from the contact chamber, in respective connector coupling and uncoupling operations, the contact area also being filled with electrically insulating fluid and separated from the rest of the connector by a third seal provided on the piston element or in the contact chamber.

The result of this arrangement is that the female connector element can comprise a rigid external body made of material that is insensitive to solvents.

The external deformable flexible wall element, sensitive to solvents, can, however, be fitted so as to be exchangeable.

The coupling contact area of the pin and of the contact chamber can be formed by a front part of the contact chamber, receiving in service the active conductive part of the pin, at the front of the latter, for example, through a set of annular cells clamped on the active conductive part of the pin.

The piston element is fitted returned towards the front, at the edge of the opening of the connector element, advantageously, by a spring means positioned at the rear of the piston element around the contact chamber, which is sheathed by an electrical insulator over all its surface area apart from the contact area.

With this arrangement, this spring means can also be used, for example by a common end strand, to return other piston elements of contact chambers of other contacts arranged in the connector element, in the case of connectors with multiple contacts.

Naturally, the rear part of the contact chamber, not contained by the piston element, is also filled with electrically insulating fluid, via an appropriate hole through its wall. Also, a drying seal element positioned between the wall of the piston element and the contact chamber is fitted on the periphery of the piston element or in an appropriate position in the contact chamber upstream of the contact area relative to the opening, to separate the contact area filled with electrically insulating fluid from the contact chamber and avoid any trace of water or external liquid medium in the contact area on coupling.

The invention is illustrated below by an exemplary embodiment and with reference to the appended drawings, in which:

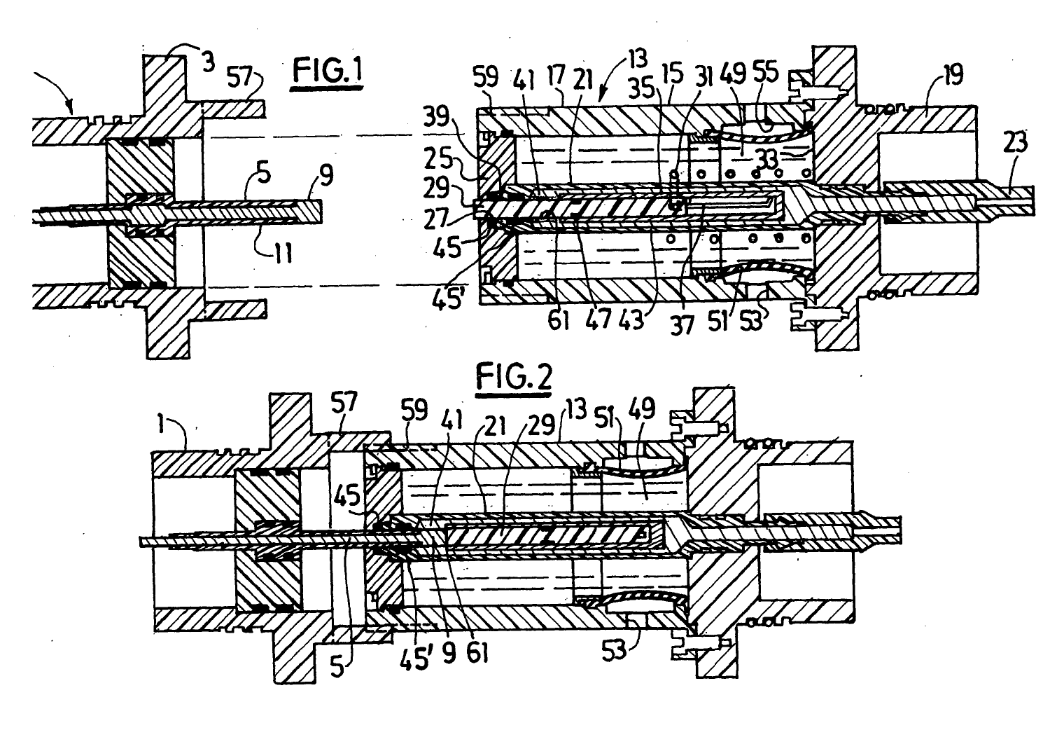

FIG. 1 is an axial cross-sectional view of a connector according to the invention in the uncoupled position, and

FIG. 2 is a view similar to FIG. 1, showing the connector in the coupled position.

The electrical connector according to the invention represented in the drawing comprises two complementary connector elements, designed to be coupled in service to each other, respectively a male connector element 1 and a female connector element 13.

It has an axial symmetry.

The male connector element 1 has a simplified structure, mainly comprising a casing 3 axially housing a cylindrical contact pin 5, fixed projecting toward the front and linked to a rear electrical cable 7. This pin has a circular section, but can be of any other shape, preferably rounded, even polygonal.

The pin 5 comprises a conductive part 9 at the end of its front peripheral surface, the rest of its surface being sheathed with electrically insulating material 11.

The female connector element 13 also comprises a body part or rigid casing 15 of section similar to that of the male element 1, this body part comprising two parts, respectively front 17 and rear 19, joined together by screws.

A contact chamber 21 is fitted axially between said front body part 17 and rear body part 19, being linked to an electrically conductive cable 23. This chamber 21 is fitted on the body part 19 and on the front face 25 of the body part 17, the latter having a circular front axial opening 27, of section complementing that of the pin 5 plus the passage clearance.

This opening 27 is arranged at the front of the chamber 21, a short distance from the latter. It is closed by a piston element or shuttle 29, of cylindrical configuration, fitted to slide axially in the contact chamber 21. This electrically insulating piston element 29 is returned toward the front, to the level of the opening 27, by a rear helical spring 31, linked to the rear end of the piston element 29 and bearing on the front face 33 of the rear body part 19. The spring 31 is fitted around the contact chamber 21, its front strand 35 passing through the contact chamber 21 through an axial slot 37 of a length equal to that of the travel of the piston element.

The piston element 29, the contact area, the contact chamber 21 in its part behind the piston and the interior of the front connector part 17 are filled with an electrically insulating fluid, and in particular electrically insulating oil, which is naturally water-repellent, promoting the freedom of the sliding motion of the piston element in the contact chamber.

The piston element 29 is in communication by its front end part with the insulating oil circulating in an annular chamber 39 formed at the front of the contact chamber 21 in the front face 25 of the connector element, and by its rear part with the insulating oil in the contact chamber 21.

This contact chamber 21 comprises an active internal conductive part 41 in its front part, which complements that 9 of the pin of the male element, the rest of its surface being covered with an electrically insulating sheath 43.

The piston element 29 is dried of all traces of surrounding fluid when it slides through the bore of the contact chamber 21 by means of two front annular seals 45, 45′ and a rear annular seal 47 fitted on its periphery, midway along the latter, and behind the conductive area 41.

The first seal 45 of the front set is fixed on the front face 25 of the connector, the second 45′ being fixed inside the front part of the contact chamber 21.

These seals are flexible lip seals or ring seals rubbing on the surface of the piston element 29. Thus, the latter, in the course of its sliding travel, frees the conductive area 41 of the contact chamber of all traces of external fluid (sea water) that could adversely affect the good contact of the contact areas that are in contact, respectively 9, 41 with the pin and of the contact chamber, when the connector elements 1 and 13 are coupled, this area remaining filled with electrically insulating oil that is neutral to the contact.

The seals 45′ and 47 have the more specific effect of separating the contact area from the rest of the connector, so forming an additional sealing barrier with respect to any external polluting fluid that could penetrate into the connector.

The variation of internal volume inside the female connector element, contained by the insulating fluid 49, is compensated by a flexible elastomer element 51 positioned at the rear of the front body part 17 and just under its periphery over a small width. This flexible element 51 takes the form of a deformable sleeve, fixed in a sealed manner by its edges respectively on a corresponding recess of the front body part 17, and a complementary recess of the rear body part 19. This flexible element is in communication with the external fluid 49 (sea water) by means of peripheral holes 53 formed in the wall of the underlying recess 55 in the front body part 17 and its wall is able to deform in this recessed space 55. It can be exchanged when worn by separating the body parts 17 and 19.

There now follows a description of how the connector operates.

The pin 5 of the male connector element simply plugs into the opening 27 in the front of the female connector element, the pin 5 pushing the piston element 29 inside the contact chamber, against the return of the spring 31. The flexible element 51 is deformed outward to take up the increase in volume induced by the introduction of the pin. In this operation, the piston element 29 is wiped dry by the seals described previously, as is the pin 5 when it passes over the front seals 45, 45′.

The plugging-in is guided by a toe piece 57 projecting around the periphery of the front face of the male element, sliding into a complementary peripheral longitudinal groove 59 in the body of the female element.

At the end of travel (FIG. 2), when the male element 1 and female element 13 are abutting, the contact area 9 of the pin, cleared of all traces of polluting external medium, is received perfectly by the corresponding contact area 41 of the contact chamber, the cells 61 of the latter applying clamping pressure on the smooth conductive part 9 of the pin.

The connector elements are uncoupled by an extraction operation that is the reverse of the coupling operation, the piston element 29 then returning to the level of the opening 27.

1. An electrical connector connectable in water or in a liquid medium, comprising two complementary connector elements, respectively a male element (1) and a female element (13) intended to be coupled together in service in said liquid medium, the male connector element (1) comprising at least one contact pin (5) projecting from the connector element, and the female connector element (13) comprising at least one opening (27) for the pin (5) to pass through to couple said connector elements, this opening (27) being blocked, in the uncoupled position, by an electrically insulating piston element (29) fitted to slide inside the connector element in an electrically insulating rigid contact chamber (21), which receives via a contact area (41) the contact pin (5) of the male connector element on coupling, the piston element (29) and the contact pin (5) also sliding in a sealed manner on coupling into the contact chamber (21) via at least two axially separate seals, one (45) of which is located close to said opening (27) and the second (45′) being located downstream of the contact area (9, 41) of the pin and of the contact chamber with respect to the opening (27), the surface of the piston element (29) between the two seals (45, 45′) being linked to a chamber filled with electrically insulating fluid (49), formed inside the connector element, this chamber being linked to an external flexible wall element (51) that deforms to accept the insertion or removal of the contact pin (5) into or from the contact chamber (21), in respective connector coupling and uncoupling operations, the contact area also being filled with electrically insulating fluid and separated from the rest of the connector by a third seal (47) provided on the piston element (29) or in the contact chamber (21), the rear part of the contact chamber (21), not contained by the piston element (29), also being filled with electrically insulating fluid via an appropriate hole through its wall, and said drying seal element (47) of the wall of the piston element (29) fitted on the periphery of the piston element (29) or in an appropriate position in the contact chamber, separating the contact area filled with electrically insulating fluid from the contact chamber, so to avoid any trace of water or of polluting external liquid medium in the contact area (9, 41) on coupling.

2. The electrical connector as claimed in claim 1, characterized in that the female connector element (13) comprises a rigid external body (17, 19) made of material that is insensitive to solvents.

3. The electrical connector as claimed in claim 1, characterized in that the deformable flexible element (51) is mounted so as to be exchangeable.

4. The electrical connector as claimed in claim 1, characterized in that the contact pin (5) of the male connector element (1) comprises a conductive part (9) at its front end, the rest of its surface being sheathed with electrically insulating material (11) and, similarly, the contact chamber (21) comprises an active internal conductive part (41) in its front part, complementing that of the pin (5), the rest of its surface being covered with electrically insulating material (43).

5. The electrical connector as claimed in claim 4, characterized in that the conductive part (41) of the contact chamber receives, in service, when the connector elements are coupled, the pin (5), for example, through a set of annular cells (61) clamped on the pin (5).

6. The electrical connector as claimed in claim 1, characterized in that the piston element (29) is fitted returned towards the front, at the edge of the opening (27) of the connector element, by a spring means (31) positioned at the rear of the piston element (29) around the contact chamber (21).

7. The electrical connector as claimed in claim 6, characterized in that the spring means (31) serves to return other piston elements (29) of contact chambers (21) of other contacts arranged in the connector element (13), in the case of connectors with multiple contacts (5, 21).

8. The electrical connector as claimed in claim 6, characterized in that said spring means (31) is a helical spring linked to the rear end of the piston element (29) and bearing on a rear part of the connector body (13), this spring (31) being fitted around the contact chamber (21), its front strand (35) passing through the contact chamber (21) through an axial slot (37) of a length equal to that of the travel of the piston element (29).

9. The electrical connector as claimed in claim 1, characterized in that said flexible element (51) takes the form of a deformable sleeve, fixed by its edges in a sealed manner to the connector body, being in communication with the external fluid (49) by means of peripheral holes (53) formed in the wall of an underlying recess (55) in the body part (17) and its wall is able to be deformed in said recess (55).
